(19) United States
(12) Patent Application Publication
(10) Pub. No.: US 2006/0177632 A1
(43) Pub. Date: Aug. 10, 2006

(54) Beta-nucleation concentrates for film applications

(76) Inventor: Philip Jacoby, Marietta, GA (US)

Correspondence Address: NEEDLE & ROSENBERG, P.C., SUITE 1000, 999 PEACHTREE STREET, ATLANTA, GA, 30309-3915, US

(21) Appl. No.: 11/053,519

(22) Filed: Feb. 8, 2005

(51) Int. Cl. B32B 3/10

(52) U.S. Cl. 428/131

(57) ABSTRACT

In one aspect, the invention is directed to a concentrate comprising a polypropylene resin and a beta-nucleating agent, wherein the nucleating agent is present in a concentration in the concentrate in a range of from about 0.005% to about 2.0%. In another aspect, the invention is directed to an extruded polypropylene sheet comprising a beta-nucleating agent concentrate in a concentration of between about 0.5% to about 50% by weight of the total polypropylene content. In a further aspect, the invention is directed to a method of manufacture of a beta-nucleating agent/polypropylene concentrate comprising the step of blending a substantially pure beta-nucleating agent with a substantially non-nucleated polypropylene resin to provide a concentration in the concentrate of from about 0.005% to about 2.0%. In yet another aspect, the invention is directed to a film produced by stretching the sheet.

### FIELD OF THE INVENTION

The present invention relates to beta-nucleation concentrates and methods for making and using such concentrates. In particular, a beta nucleation concentrate is added to the non-nucleated polymer to form beta spherulites in an extruded sheet, which is then stretched in at least one direction to produce a microporous film.

### BACKGROUND OF THE INVENTION

Opaque polypropylene film can be produced by stretching an extruded polypropylene sheet containing a filler or a colorant such as talc, clay, calcium carbonate, or TiO2. It is known to those skilled in the art that beta-crystalline polypropylene can be used to produce opaque films without adding any filler or colorant. Such films owe their opacity to the presence of numerous pores throughout the film that are formed when the extruded sheet is stretched either uniaxially or biaxially in the solid state, below the melting point of the beta crystal phase

Opaque, microporous polypropylene films have many applications in such areas as labels, food packaging, tape, battery separators, and breathable films which are used in protective clothing, disposable diaper backsheets, and construction applications such as housewrap and roofing membranes. The porosity generated during the production of the film lowers the film density thereby increasing the surface area of film that can be produced by a given weight of polypropylene.

In order to take advantage of the unique attributes of beta crystalline polypropylene to produce opaque microporous films, one can incorporate a beta nucleating agent into the resin. There are a very limited number of commercially available beta nucleated polypropylene resins, and the film producer would have to choose one of these resins. Often the commercially available beta nucleated polypropylene resin is not the one that is best suited for a particular film application due to its molecular weight or melt viscosity, or because a particular copolymer resin is needed for the application. It is difficult to add the beta nucleant directly to the non-nucleated resin of choice, since the nucleant is generally a very fine powder which does not mix uniformly with the resin pellets. In this case it is more convenient to use a beta nucleating agent that is contained within a pellet masterbatch. This masterbatch contains a much higher concentration of the beta nucleant than is desired in the final extruded sheet, so the masterbatch is typically added at a concentration of a few percent to the non-nucleated resin, before it is extruded into sheet.

Through use of a pellet masterbatch, the film fabricator is free to choose the best polypropylene resin for the application, and then add the beta nucleant masterbatch to this resin to achieve a high level of beta crystal content in the extruded sheet.

By using a beta nucleant masterbatch, a more rapid transition from the production of a beta nucleated sheet to a non-nucleated sheet on the same extruder can be achieved. If a fully formulated beta nucleated polypropylene resin is used there is often a long transition period which follows the change-over to a non-nucleated polypropylene sheet, since all of the beta nucleant from the first resin must be flushed out of the system before a 100% non-nucleated sheet product can be produced. In situations where the non-nucleated polypropylene film needs to have a high level of see-through clarity the presence of any residual beta spherulites in the extruded sheet can lead to a decrease in film clarity after the sheet is stretched due to some microvoiding that may occur. By reducing the transition time between the production of beta nucleated and non-nucleated polypropylene sheet, the amount of off-grade product or scrap can be reduced.

Crystalline polypropylene (also known as “isotactic polypropylene”) is capable of crystallizing in three polymorphic forms: the alpha, beta and gamma forms. In melt-crystallized material the predominant polymorph is the alpha or monoclinic form. The beta or pseudohexagonal form generally occurs at levels of only a few percent, unless certain heterogeneous nuclei are present or the crystallization has occurred in a temperature gradient or in the presence of shearing forces. The gamma or triclinic form is typically only observed in low-molecular weight or stereoblock fractions that have been crystallized at elevated pressures.

The alpha form also is also referred to as “alpha-spherulites” and “alpha-crystals.” The beta form is also referred to as “beta-spherulites,” “beta-crystals,” “beta-form spherulites,” or “beta-crystallinity.” Beta-crystals have a melting point that is generally 10-15° C. lower than that of alpha-crystals.

Generally, extruded polypropylene sheets primarily contain alpha spherulites. Beta nucleants can be added to a polypropylene resin to increase the amount of beta spherulites in the resulting polypropylene sheet.

Porous polypropylene films containing beta spherulites have been used as microporous films. (See U.S. Pat. No. 4,975,469 to P. Jacoby and C. Bauer) The presence of beta nucleants results in the formation of beta spherulites in the sheet, which produce a microporous structure in the resulting stretched film. The micropores allow gases to permeate through the film.

Similarly, beta nucleants have been added to thermoformable thermoplastic resin polypropylene in order to broaden the temperature range over which the sheets can be processed and to prevent sag in the thermoforming oven. (See U.S. Pat. No. 5,310,584 to Jacoby et al. The beta nucleants induce microvoiding in the sheet when it is deformed during the thermoforming process. Sheets containing high levels of beta spherulites can be thermoformed at lower temperatures than polypropylene sheets formed from alpha nucleated polypropylene or non-nucleated polypropylene since the beta spherulites melt at a lower temperature than the alpha spherulites. This allows the sheets to soften without excessive sag in the thermoforming oven.

Therefore provided herein is a beta nucleant masterbatch that can be added to a non-nucleated polypropylene resin to produce an extruded sheet containing high levels of beta crystallinity. When this sheet is stretched either monoaxially or biaxially to produce a film, the film has a high level of opacity and microvoiding and a reduced density compared to that of film made from a non-beta nucleated precursor sheet.

Also provided herein is a more convenient way for a film producer to incorporate a beta nucleating agent into a non-nucleated polypropylene resin. Accordingly, the transition time that is needed to go from the production of a beta nucleated polypropylene sheet to the production of a non-nucleated polypropylene sheet is reduced.

### BRIEF SUMMARY OF THE INVENTION

Beta nucleation agents can be used to impart improved properties in polypropylene materials such as sheets and specialty items, for example, oriented films produced from extruded sheets. A convenient way of incorporating beta-nucleating agents into polypropylene used to fabricate an extruded product is through the use of a concentrate. A concentrate is defined as a highly loaded, pelletized polypropylene resin containing a higher concentration of nucleating agent then is desired in the final extruded sheet (product). In one aspect, the nucleating agent is present in the concentrate in a range of from about 0.005% to about 2.0% (from about 50 ppm to about 20,000 ppm) and, in another aspect, in a range of from about 0.0075% to about 1% (from about 75 ppm to about 10,000 ppm). In yet another aspect, the nucleating agent is present in the concentrate in a range of from 0.0075% to about 0.0500% (from about 75 ppm to about 500 ppm). In one aspect, typical concentrates are blended with non-nucleated polypropylene in the range of from about 0.5% to about 50% of the total polypropylene content of the extruded product and, in another aspect, the range can be from about 1% to about 10% of the total polypropylene content of the extruded product. In one aspect, the concentration range of nucleant in the final extruded sheet product is from about 0.00005% to about 1.0% (from about 0.5 ppm to about 10000 ppm) and, in another aspect, from about 1 ppm to about 2000 ppm.

The concentrate can also contain other additives, such as stabilizers, pigments, and processing agents. A concentrate containing a beta-nucleating agent generally does not contain any additives which nucleate the alpha crystal form of polypropylene.

Methods for the manufacture and use of, as well as compositions incorporating, these concentrates are described.

Additional advantages will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 illustrates the production of the biaxially oriented film produced from an extruded sheet using the tenter frame process.

FIG. 2 illustrates the production of a biaxially oriented film from an extruded tube using the double bubble process.

### DETAILED DESCRIPTION OF THE INVENTION

Before the present compounds, compositions, articles, devices, and/or methods are disclosed and described, it is to be understood that the aspects described below are not limited to specific synthetic methods, as such may, of course, vary. It is also to be understood that the terminology used herein is for the purpose of describing particular aspects only and is not intended to be limiting.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if an inhibitor is disclosed and discussed and a number of modifications that can be made to a number of R groups are discussed, each and every combination and permutation of the inhibitor and the modifications to its R group that are possible are specifically contemplated unless specifically indicated to the contrary. Thus, if a class of substituents A, B, and C are disclosed as well as a class of substituents D, E, and F and an example of a combination molecule, A-D is disclosed, then even if each is not individually recited, each is individually and collectively contemplated. Thus, in this example, each of the combinations A-E, A-F, B-D, B-E, B—F, C-D, C-E, and C—F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B—F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

It must be noted that, as used in the specification and the appended claims, the singular forms “a,” “an” and “the” include plural referents unless the context clearly dictates otherwise. Thus, for example, reference to “an aromatic compound” includes mixtures of aromatic compounds; reference to “a polymer carrier” includes mixtures of two or more such carriers, and the like.

“Optional” or “optionally” means that the subsequently described event or circumstance can or cannot occur, and that the description includes instances where the event or circumstance occurs and instances where it does not. For example, the phrase “optionally substituted lower alkyl” means that the lower alkyl group can or can not be substituted and that the description includes both unsubstituted lower alkyl and lower alkyl where there is substitution.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

I. Compositions

A. Polymer

Various types of polyolefin resins can be used as the starting base resin. In one aspect, the polyolefin resin is a resinous polymer containing propylene. The polymer can be a homopolymer of polypropylene, a random or block copolymer of propylene and another α-olefin or a mixture of α-olefins, or a blend of a polypropylene homopolymer and a different polyolefin. For the copolymers and blends, the α-olefin can be polyethylene or an α-olefin having 4 to 12 carbon atoms. In one aspect, the α-olefin contains 4 to 8 carbon atoms, such as butene-1 or hexene-1. In one aspect, at least about 50 mol % of the copolymer is formed from propylene monomers. The copolymer can contain up to about 50 mol %, for example up to about 40 mol %, of ethylene or an α-olefin having 4 to 12 carbon atoms, or mixtures thereof. Blends of propylene homopolymers with other polyolefins, such as high density polyethylene, low density polyethylene, or linear low density polyethylene and polybutylene can be used.

The melt flow rate (herein after referred to as “MFR”) measured in accordance with ASTM-1238, of the polypropylene-based concentrate is generally about 0.1 to 100 g/10 minutes, for example, about 0.3 to 50 g/10 minutes.

B. Beta Nucleating Agents

In one aspect, the beta spherulites are formed through the addition of a beta nucleating agent. H. J. Leugering, Makromol. Chem. 109, 204 (1967) and A. Duswalt et al., Amer. Chem. Soc. Div. Org. Coat., 30, No. 2 93 (1970) disclose the use of certain nucleating agents to cause the preferential formation of beta-form spherulites. The structure of the nucleant can induce the formation of crystals with a defined structure.

Alternative procedures known for preferentially inducing the formation of the beta-form spherulites generally do not form controlled amounts of beta-spherulites. These methods include crystallizing from a melt undergoing shear deformation (see e.g. Leugering et al., Die Angew. Makro. Chem. 33, 17 (1973) and H. Dragaun et al., J. Polym. Sci., 15, 1779 (1977)) and zone-crystallization in a temperature gradient (see e.g. Lovinger et al., J. Polym. Sci., 15, 641 (1977)).

In contrast, nucleating agents can form beta-spherulites in a more controlled concentration than these nucleation methods. In one aspect of the invention, the nucleating agent can be any inorganic or organic nucleating agent that can produce beta-spherulites in the melt-formed sheet at a concentration corresponding to a K-value obtained by x-ray diffraction analysis of 0.2 to 0.95. Alternatively, the efficiency of the beta nucleating agent and the concentration of beta spherulites in a polypropylene sample can be measured by the size of the melting endotherm observed in a differential scanning calorimeter (DSC) corresponding to the melting of the beta crystals.

Only a few materials are known to preferentially nucleate beta-form spherulites. Any such preferential beta-nucleators can be used in the invention. Mixtures of the various beta-spherulite nucleating agents can be used. Suitable beta-nucleators include, but are not limited to:

(a) the gamma-crystalline form of a quinacridone colorant Permanent Red E3B, herein referred to as “Q-dye.” The structural formula for Q-dye is:

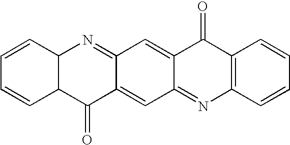

(b) the bisodium salt of o-phthalic acid;

(c) the aluminum salt of 6-quinizarin sulfonic acid;

(d) isophthalic and terephthalic acids; and

(e) N′,N′-dicyclohexyl-2,6-naphthalene dicarboxamide, also known as NJ Star NU-100, developed by the New Japan Chemical Co.

Another suitable beta-nucleating agent is disclosed in German Patent DE 3,610,644. This beta-nucleating agent is prepared from two components, (A) an organic dibasic acid, such as pimelic acid, azelaic acid, o-phthalic acid, terephthalic acid, and isophthalic acid; and (B) an oxide, hydroxide or an acid salt of a metal of Group II, such as magnesium, calcium, strontium, and barium. The acid salt of the second component (B) may be derived from an organic or inorganic acid, such as a carbonate or stearate. The composition can contain up to about 5 wt % of Components A and B (based the weight of the polymer) and preferably contains up to about 1 wt % of Components A and B.

Materials that preferentially nucleate beta-form spherulites generally do not appreciably nucleate the alpha crystal form of polypropylene. In one aspect, a material that does not appreciably nucleate that alpha crystal form of polypropylene produces polypropylene wherein less than about 5% of the crystallized polypropylene is in the alpha form. In another aspect, the material produces polypropylene wherein less than about 2% of the crystallized polypropylene is in the alpha form. In a further aspect, the material produces polypropylene wherein less than about 1% of the crystallized polypropylene is in the alpha form. In yet another aspect, the material produces polypropylene wherein less than about 0.5% of the crystallized polypropylene is in the alpha form. It is also understood that the amounts of beta-nucleation and alpha-nucleation can vary depending upon the concentration of the nucleant in the polypropylene.

The properties of the resulting extruded sheet are dependent on the selection of the beta nucleant and the concentration of the beta nucleant. Suitable concentration ranges for the beta nucleant depend on which beta nucleant is selected. The amount of nucleant depends on the effectiveness of the particular nucleant in inducing beta-crystals and the thermal conditions under which the sheet is produced. The Q-dye can be most effective at very low levels, in the range of from about 0.1 ppm to about 100 ppm. In one aspect, the beta nucleant can be quinacridone colorant Permanent Red E3B and can be present in the composition at a level of from about 0.5 ppm to about 50 ppm, based on the weight of the resinous polymer of propylene. For other beta nucleants, concentrations in the range of from about 200 ppm to about 5000 ppm can be used in order to produce an extruded sheet that has a K value in the desired range.

As used herein, the amount of nucleant can be calculated based on studies using Q-dye. It is understood that other beta-nucleants may have different activities and that different amounts could be required to result in the same amount of nucleation and formation of beta spherulites in the final product.

The nucleating agents are typically in the form of powdered solids. To efficiently produce beta-crystallites, the powder particles are generally less than about 5 microns in diameter, for example, no greater than about 1 micron in diameter.

C. Additives

The resinous polymer of propylene can be admixed as needed with a variety of additives, including lubricants, antioxidants, ultraviolet absorbers, radiation resistance agents, antiblocking agents, antistatic agents, coloring agents, such as pigments and dyes, opacifiers, such as TiO₂ and carbon black. Standard quantities of the additives can be included in the resin. Care is generally taken to avoid incorporation of other nucleating agents or pigments that act as nucleating agents, since these materials can prevent the proper nucleation of beta-spherulites. Alpha nucleating agents that are generally omitted from the formulation include, but are not limited to, talc, sodium benzoate; lithium benzoate, NA-11 from Amfine, which is the sodium salt of 2,2′-methylene bis (4,6-di-tert-butylphenyl) phosphate; and sorbitol clarifiers, such as Millad 3988 from Milliken Chemicals (i.e., bis(3,4-dimethylbenzylidene) sorbitol). Radical scavengers, such as dihydroxy talcite, are also generally avoided, since they have some nucleating ability.

Mineral materials used as whiteners or opacifiers, such as barium sulfate (BaSO₄), titanium dioxide (TiO₂), and calcium carbonate (CaCO₃), may be added to the resin. The effective amount of such additives can depend upon the particular application or end-use intended for the plastic film and can range from 0.005 to about 5 wt %, based on the weight of the polymer.

Antistatic agents can include, but are not limited to, alkali metal alkane sulfonates, polyether-modified (i.e., ethoxylated and/or propoxylated) polydiorganosiloxanes, and substantially linear and saturated aliphatic tertiary amines containing a C₁₀₋₂₀ aliphatic radical and substituted by two C₁₋₄ hydroxyalkyl groups, such as N,N-bis-(2-hydroxyethyl)-alkyl amines containing C₁₀₋₂₀, preferably C₁₂₋₁₈, alkyl groups.

Suitable antiblocking agents include inorganic additives, such as silicon dioxide, calcium carbonate, magnesium silicate, aluminum silicate, calcium phosphate; nonionic surfactants; anionic surfactants; and incompatible organic polymers, such as polyamides, polyesters, and polycarbonates. Examples of lubricants include higher aliphatic acid amides, higher aliphatic acid esters, waxes, and metal soaps.

Additives can interfere with nucleation. For example, high concentrations of carbon black and certain pigments can inhibit nucleation, thereby requiring higher concentrations of nucleants to produce an equivalent amount of nucleation. As used herein, concentrations of nucleants can be calculated based on the amount required in the absence of additives, with the understanding that variation in amounts can be required to adjust for the presence of other additives. Typically, the amount of nucleant can be increased as additives are incorporated into the polypropylene.

D. Concentrates Containing a β-Nucleating Agent

A convenient way of incorporating beta-nucleating agents into polypropylene used to fabricate an extruded product can be through the use of a concentrate. A concentrate can be defined as a highly loaded, pelletized polypropylene resin containing a higher concentration of nucleating agent than is generally desired in the final extruded sheet (product). In one aspect, the nucleating agent is present in the concentrate in a range of from about 0.005% to about 2.0% (from about 50 ppm to about 20,000 ppm), in another aspect, in a range of from about 0.0075% to about 1% (from about 75 to about 10,000 ppm). In yet another aspect, the nucleating agent is present in the concentrate in a range of from 0.0075% to about 0.0500% (from about 75 ppm to about 500 ppm). Typical concentrates can be blended with non-nucleated polypropylene in the range of from about 0.5% to about 50% of the total polypropylene content of the extruded product. In one aspect, the range is from about 1% to about 10% of the total polypropylene content of the extruded product. For example, the concentration range of nucleant in the final extruded sheet product can be from about 0.00005% to about 0.1% (from about 0.5 ppm to about 1000 ppm). As a further example, the concentration can be from about 1 ppm to about 200 ppm. A concentrate can also contain other additives such as stabilizers, pigments, and processing agents. A concentrate containing a beta-nucleating agent generally does not contain any additives that nucleate the alpha crystal form of polypropylene.

The concentrate can be made from a polyolefin carrier resin. The carrier resin used to make the concentrate can be polypropylene homopolymer, polypropylene copolymers containing other alpha-olefin monomers, or other polyolefins. As used herein, polypropylene means a polypropylene homopolymer or a polypropylene copolymer containing other alpha-olefin monomers. The melt flow rate of the carrier resin can influence the melting and dispersability of the nucleating agent and is typically equal to or higher than the melt flow rate of the base polypropylene.

A concentrate can be made by melt blending the pure nucleating agent with a non-nucleated polypropylene resin using a twin screw extruder or other appropriate mixing device, such as a Banbury mixer. The non-nucleated polypropylene resin can be in either powder or pellet form. If a powder is used, additional stabilizing agents, such as anti-oxidants, can also be incorporated. One method for making concentrates can be to first prepare a powdered pre-master batch by blending the powdered polypropylene and powdered nucleant in a high intensity mixer, such as a Henschel mixer. This powdered pre-master batch can then be blended with additional non-nucleated polypropylene powder in a twin-screw extruder.

A concentrate can also be made using a double-compounded master batch. In this process, a pelletized single-pigment master batch can be made by extruding a blend of the pure nucleating agent and non-nucleated polypropylene. The nucleating agent can be present in a concentration of from about 10% to about 50% of the total polypropylene content of the concentrate. The single-pigment master batch can then be diluted down a second time with pure polypropylene, for example, to a ratio of 100 to 1, resulting in a concentrate with a nucleant concentration of from about 0.1% to about 0.5% of the total polypropylene content. This second master batch can be fturther diluted by blending the concentrate with additional non-nucleated polypropylene.

Typically, from about 5% to about 10% by weight of the concentrate can be blended with from about 90% to about 95% by weight non-nucleated polypropylene resulting in a concentrate which has been diluted down by a factor of from about 10 to about 20, to a final concentration of nucleant in the concentrate of from about 0.005% to about 0.05% by weight (from about 50 ppm to about 500 ppm). If the quinacridone pigment is used as the beta nucleant for the production of microporous oriented polypropylene film, the concentrate can contain from about 50 ppm to about 200 ppm of the beta nucleant.

E. Method of Incorporating Concentrate into Polyolefin Resin

Pelletized master batch concentrate can be added into the hopper end of a sheet extruder using a loss-in-weight, gravimetric or volumetric feeder. The hopper also can contain pellets of the non-nucleated polypropylene resin. Additional feeders can be used to incorporate other additives in concentrate form such as carbon black, other pigments and stabilizers. Concentrate containing the nucleating agent can be added to polypropylene to form the final product in an amount of from about 0.5% to about 50% by weight. For example, concentrate can be added in an amount of from about 1% to about 10% by weight. The mixture can then be fed into the feed throat of the extruder and melt blended to form a homogeneous melt. The extruder can be a single or twin-screw extruder. Further, the extruder can optionally contain a static mixer and/or melt pump to further homogenize the blend and control the output rate of the extruder.

II. Method for Making Extruded Polypropylene Sheet Containing a high level of Beta Crystallinity, and Oriented Film Produced From This Sheet

The method of producing the final uniaxially or biaxially oriented polypropylene film can be achieved via the following steps:

1. Melt forming a polymeric composition that contains a crystalline resinous polymer of propylene containing an effective amount of nucleating agent capable of producing beta spherulites in the solidified sheet.

2. Quenching the melt-formed sheet at a quench temperature sufficient to produce beta-spherulites in the sheet. In one aspect, the resulting sheet has a K-value of ranging from about 0.1 to about 0.95, in another aspect, ranging from about 0.2 to about 0.95. Alternatively the resulting sheet can show a prominent melting peak for the beta crystal phase when a sample of the sheet is placed in a DSC and heated at a rate of about 10° C. per minute.

3. Extruding the quenched sheet.

4. Orienting the solid sheet in the machine direction by passing it over a series of heated rollers moving at different speeds at a sufficient temperature to achieve draw ratios ranging from about 2:1 to about 10:1. Here the drawing can occur as the sheet passes from the slowly rotating roll to the rapidly rotating roll, and the draw ratio can be defined as the ratio of the speed of the fast draw roll to the speed of the slow draw roll.

5. For biaxially oriented film products, the uniaxially drawn sheet can be heated to a temperature sufficient to orient it in a direction perpendicular to the MD at draw ratios ranging from about 2:1 to about 10:1.

6. An alternative method for producing a biaxially oriented film can be to simultaneously orient the film in two directions by extruding a tubular sheet from an annular die, and then cooling the tube over a mandrel or by spraying water on the tube, and then reheating the tube and applying internal air pressure to re-inflate the tube to form a biaxially oriented bubble, which can then be slit and wound up onto a roll. This “double bubble” process is widely practiced. The beta nucleant concentrate of this invention can be blended into the polypropylene resin used to extrude the tube in the same manner as that used for flat extruded sheet, in order to take advantage of the unique property enhancements deriving from the use of beta nucleation.

In one aspect, the sheet can be perforated. After biaxial stretching, the sheet can form a web or grid. In another aspect, the sheet can be unperforated, or solid. After stretching, the sheet can form a film. Although referred to as solid, it is understood that such a sheet containing beta-nucleating agents, when stretched, can undergo microvoiding.

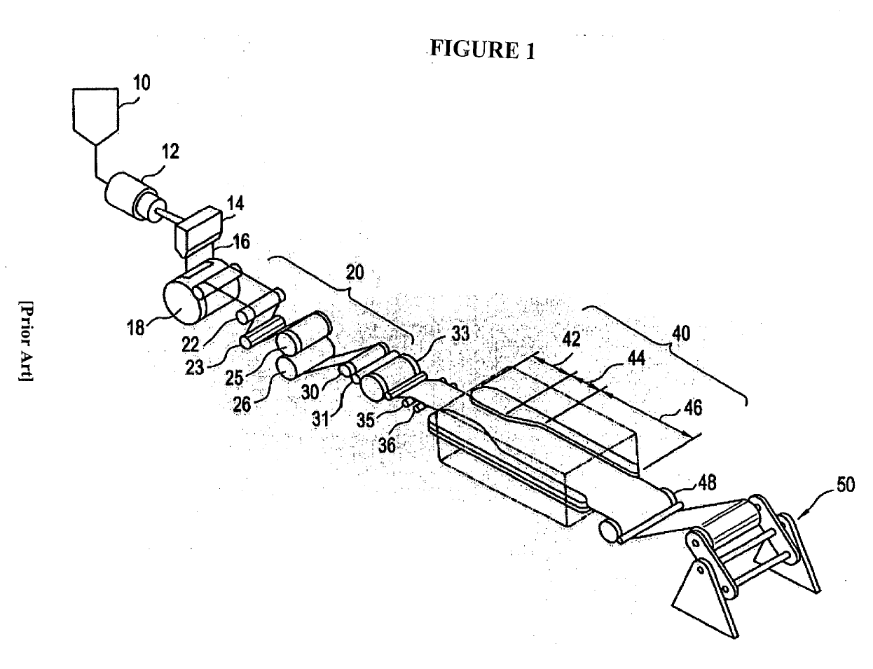

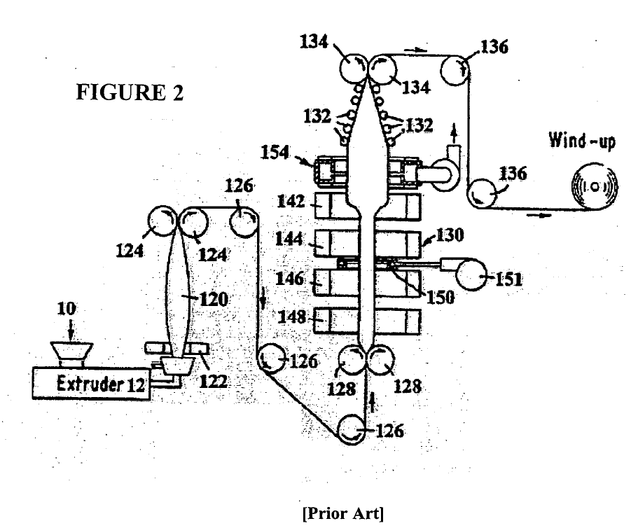

FIGS. 1 and 2 illustrate steps 5 and 6 used in the process for manufacturing the oriented film.

An example of the use of tenter frames is disclosed in U.S. Pat. No. 6,207,093 to Hanyu et al. FIG. 1, reproduced from Hanyu et al., illustrates the apparatus described in the Hanyu et al. patent that may be employed in producing biaxially-oriented polypropylene film in accordance with the present invention. More particularly and with reference to FIG. 1, a source of molten polymer can be supplied from a heated hopper 10 to an extruder 12 and from there to a slot die 14 which produces a flat, relatively thick film 16 at its output. Film 16 can be applied over a chill roller 18 and cooled to a suitable temperature within the range of from about 80° C. to about 130° C. The film can be drawn off the chill roller 18 to a stretching section 20 to which the machine direction orientation occurs by means of idler rollers 22 and 23 which lead to preheat rollers 25 and 26.

As the film is drawn off the chill roller 18 and passed over the idler rollers, it can be cooled to a temperature of from about 30° C. to about 60° C. In stretching the film in the machine direction, it can be heated by preheat rollers 25 and 26 to an incremental temperature increase of from about 60° C. to about 100° C. and then passed to the slow roller 30 of the longitudinal orienting mechanism. The slow roller may be operated at any suitable speed, in one aspect from about 20 feet per minute to about 40 feet per minute in this type of pilot production line. The fast roller 31 can be operated at a suitable speed, in one aspect about 150 feet per minute, in a pilot line, to provide a surface speed at the circumference of about 4 to about 7 times that of the slow roller in order to orient the film in the machine direction. In a commercial production line, casting speeds can be much higher, such as from about 20 to about 60 meters per minute. In one aspect, final speeds can be from about 120 to about 360 meters per minute.

As the oriented film is withdrawn from the fast roller, it can be passed over a roller 33 at room temperature conditions. From here it can be passed over tandem idler rollers 35 and 36 to a lateral stretching section 40 where the film can be oriented by stretching in the transverse direction. The section 40 includes a preheat section 42 comprising a plurality of tandem heating rollers (not shown) where it can be again reheated to a temperature within the range of from about 90° C. to about 140° C. From the preheat section 42 of the tenter frame, the film can be passed to a stretching or draw section 44 where it can be progressively stretched by means of tenter clips (not shown) which grasp the opposed sides of the film and progressively stretch it laterally until it reaches its maximum lateral dimension. Lateral stretching ratios are typically greater than machine direction stretch ratios and often range anywhere from 3-12 times the original width. In one aspect, ratios of from about 5 to about 10 times are usually preferred. The concluding portion of the lateral stretching phase includes an annealing section 46, such as an oven housing, where the film can be heated at a temperature within the range of from about 120° C. to about 170° C. for a suitable period in time, in one aspect, from about 1 to about 10 seconds. The annealing time helps control certain properties, and increased annealing is often specifically used to reduce shrinkage. The biaxially oriented film can then be withdrawn from the tenter frame and passed over a chill roller 48 where it can be reduced to a temperature of, in one aspect, less than about 50° C. and then applied to take-up spools on a take-up mechanism 50. From the foregoing description, it will be recognized that the initial orientation in the machine direction can be carried out at a somewhat lower temperature than the orientation in the lateral dimension. For example, the film exiting the preheat rollers can be stretched in the machine direction at a temperature of about 120° C. In one aspect, the film can be cooled to a temperature of about 50° C. and thereafter heated to a temperature of about 160° C. before it is subject to the progressive lateral dimension orientation in the tenter section.

The double-bubble process is described in U.S. Pat. No. 3,555,604 to Pahlke and incorporated herein by reference.

FIG. 2 illustrates the major components of such a double bubble processing line. The plastic feedstock 10 can be fed into extruder 12. A primary bubble 120 can form by inflating the bubble as the melt exits die 122. Primary bubble 120 is cooled and collapsed as it passes through rollers 124. The resulting collapsed tube is then re-inflated to form the second bubble. The second bubble can be heated to a draw temperature by means of external heaters 148, 146, 144, and 142. The amount of inflation determines the degree of orientation in the transverse direction. Machine direction orientation can be imparted by having speed of the exit rollers 134 greater than the inlet rollers 128.

Features required to properly control the double-bubble process are further described in the Pahlke patent. Such features can include a special design of extruder die 122, air cooling areas 151 and 154, and guide rollers 132.

For the most part, the double-bubble process can result in a biaxially oriented film that can be simultaneously oriented in both the machine and transverse directions. This is in contrast to the tenter frame processing line where first machine direction orientation can be followed by transverse (tenter direction) orientation.

A. Melt forming a polymeric composition

The nucleant can be dispersed in the resinous polymer of propylene by any suitable procedure normally used in the polymer art to effect thorough mixing of a powder with a polymer resin. For example, the nucleant can be powder blended with resin in powder or pellet form or the nucleant can be slurried in an inert medium and used to impregnate or coat the resin in powder or pellet form. Alternatively, powder and pellets can be mixed at elevated temperatures by using, for example, a roll mill or multiple passes through an extruder. An example procedure for mixing can be the blending of nucleant powder and base resin pellets or powder and melt compounding this blend in an extruder. Multiple passes through the extruder can be necessary to achieve the desired level of dispersion of the nucleant. Ordinarily, this type of procedure can be used to form a masterbatch of pelletized resin containing sufficient nucleant so that when a masterbatch is let down in ratios of from about 10/1 to about 200/1 (polymer to nucleant) and blended with the base resin, the desired level of nucleant can be obtained in the final product.

For example, in one aspect, a Q-dye masterbatch is formed by first adding a sufficient amount of the quinacridone dye to the polypropylene resin to form a polypropylene resin containing 40% of the quinacridone dye. In one aspect, 3% of this concentrate can then be extrusion compounded with an additional 97% of polypropylene to make a new concentrate that contains 1.2% of the quinacridone dye (“the 1.2% concentrate”). A third compounding step can then be performed where 3% of the 1.2% concentrate is blended with 97% of polypropylene to make a new concentrate that contained 0.036% of the quinacridone dye. This final concentrate can then be added at a 2% level to the base polypropylene used to make the extruded sheet, so that the final sheet contained 0.00072% or 7.2 ppm.

In one aspect, a multi-component blending system can be used to precisely feed the different raw materials in to the hopper of an extruder. These raw materials typically consist of a neat polypropylene resin, a masterbatch containing the beta nucleant, and “re-grind” from previous extrusion runs or edge trim that can be taken off of the extruded sheet. As generally used herein, “re-grind” refers to portions of a previously extruded sheet that are ground up an added to the raw material feed used to make new sheet. The neat polypropylene resin and the regrind generally do not contain an alpha nucleating agent. The extruder melts and homogenizes the different raw materials, and then pumps out the molten extrudate. A gear pump and a static mixer are often included in the extrusion system in order to provide for a consistent, homogeneous, and accurate flow of the polymer melt. At the end of the extruder is a sheet die which can evenly distribute the polymer melt across the desired sheet width.

B. Quenching the melt-formed sheet

In the preparation of the extruded sheet by the slit-die, T-die or other suitable process, the extruded sheet in the form of molten polymer can be quenched, or cooled, to solidify the molten sheet by a suitable quenching means. The quenching means can be capable of quenching the sheet at a rate equal to or greater than the sheet production rate, and the temperature encountered by the sheet in the quenching means can be in a range suitable to promote the development of beta-spherulites. In one aspect, the temperature range of the sheet during solidification can be from about 80° C. to about 130° C. Suitable quenching means include a single quench roll and a multi-roll quench stack, such as a two-roll, a three-roll or a five-roll quench stack. The heated roll(s) cool the sheet uniformly and control the sheet thickness. An on-line thickness profiler is typically used to control the sheet thickness to tight tolerances.

A three-roll vertical quench stack can be used with the sheet nipped between the first and the second rolls with the beta-spherulite crystallinity starting at the second or middle roll and the sheet wrapping around the middle and third rolls. The temperature of the middle roll can be at least about 80° C., in one aspect, in the range of from about 90° C. to about 130° C., for optimum production of beta-spherulites.

For a single layer sheet having beta-spherulites throughout the sheet, the temperature of the third roll can be in the range of about 80° C. to about 110° C. However, if a single layer sheet with a very small amount of beta-spherulites near the sheet surfaces and a larger amount of beta-spherulites near the center is desired, the third roll temperature can be less than about 80° C. In one aspect, the temperature of the first roll of the three-roll stack can range from about 50° C. to about 150° C. without adversely affecting the beta-form content of the sheet.

The quenching means can be positioned relatively close to the extruder die, the distance between the quenching means and the extruder die can be dependent on factors such as the temperature of the rolls, the sheet extrusion rate, the sheet thickness, and the roll speed. Typically, the distance between the extruder die lips and the gap between the first and second heated rolls can be less than about 10 cm.

The finished sheet can then be wound onto a large roll for transfer to the next step in the process.

C. Extruding the Sheet

The extruded sheet may be one layer or multi-layered. A multi-layered sheet can contain two layers, three layers, or more than three layers. Conventionally, multi-layer and single layer sheets can be melt formed by coextrusion and extrusion, respectively, by various known shaping methods such as the calender method, the extrusion method, and the casting method. An example method is melt extrusion slit-die or T-die process. Extruders used in such a melt-extrusion process can be single-screw or twin-screw extruders. Such machines are generally free of excessively large shearing stress and are capable of kneading and extruding at relatively low resin temperatures.

For producing a coextruded multi-layer sheet with one layer that contains a beta-nucleated resinous polymer, one extruder can be used to extrude a sheet of the beta-spherulite nucleated resin. A second extruder can be used to extrude a layer of non-nucleated polymer resin, which is located on at least one side of the nucleated resin. If a layer of non-nucleated resin is desired on both sides of the beta-nucleated resin, then a non-nucleated polymer melt can be split between two slit-dies and a second layer of extruded non-nucleated polymer sheet will be in contact with the other side of the beta-nucleated polymer resin layer between a second set of nip rolls.

Alternatively, more than one extruder can be used to supply molten polymer to a coextrusion die. This allows two or more distinct polymer layers to be coextruded from a given slit-die.

The temperature at the die exit can be controlled, such as through the use of a die-lip heater, to be the same as or slightly higher than the resin melt temperature. By controlling the temperature in this manner, “freeze-off” of the polymer at the die lip can be prevented.

A die free of mars and scratches on the surface can produce a sheet with smooth surfaces.

D. Orientation of the Sheet

After the sheet is extruded it can be oriented in one or two directions. During the orientation process the sheet develops micropores which can cause it to take on an opaque or translucent appearance. The final microporous films can be used in a variety of applications such as tape, labels, packaging film, or battery separators.

1. Machine Direction Orientation

If the sheet is to be oriented in only one direction, it passes through a machine direction (MD) orientation device, and is wound up on a winding unit. In one aspect, the draw ratios in the machine direction can vary from about 2:1 to about 10:1, for example, from about 3:1 to about 8:1. Hot air or heated rollers can be used to heat the sheet to the appropriate stretching temperature.

2. Transverse Direction Orientation

If the sheet is to be stretched in two perpendicular directions (i.e., biaxially oriented), the sheet can be stretched in the MD and the transverse direction (TD). The TD stretching step can occur before or after the MD orientation step. Typically, the sheet is not cooled down substantially between the first and second stretches. For the TD orientation step, the sheet can pass through an oven that can be heated using either forced air or radiant heaters. The TD orientation machine typically contains a series of clips attached to movable rails which hold the sides of the sheet. These rails diverge as the sheet passes through the TD machine, and this divergence can cause the sheet to stretch in the transverse direction. A common name for the TD orientation machine is a Tenter Frame. The TD draw ratios can be in the range of from about 2:1 to about 10:1, for example, in the range of about 3:1 to about 8:1. The overall area stretch ratio of a biaxially stretched sheet can be at least about 13:1.

FIG. 1 illustrates the formation of a monoaxially and biaxally oriented sheet. In the first orientation step, the sheet can be heated by passing over a series of heated rollers within a housing (20). The sheet can then be heated up to the point where it can be stretched. The stretching can be accomplished by rotating the last roller in the series at a higher speed. The MD oriented sheet can contain microvoids that are produced when the beta crystal phase transforms into the alpha crystalline phase during the stretching process. The MD oriented sheet is typically white/opaque in appearance.

As illustrated in FIG. 1, in the second orientation step, the MD oriented sheet can enter into a heated tenter frame (40) where the sheet is stretched in the transverse direction, i.e. at right angles to the initial MD stretch. The tenter can be heated with forced air, and there can be two rails containing a series of clips, which grip the edge of the sheet as it passes into the tenter. These rails begin to diverge (44) after the sheet enters the tenter, and can cause the sheet to be stretched in the transverse direction.

After the biaxially oriented film exits the tenter it can be wound onto a roll for shipment.

3. Temperature

In one aspect, the stretching temperature during the orientation step(s) can be below about 160° C., for example, below about 155° C. A stretching temperature of at least about 80° C. can be used, and for example, this stretching temperature can be at least about 90° C. The temperatures used to stretch the sheet can have a strong influence on its physical characteristics, including the degree of microvoiding which occurs during the stretching process. Since the beta-crystalline phase can have a lower tensile yield stress than the alpha-crystalline phase, a sheet containing a high level of beta-spherulites can be stretched at lower temperatures without breaking or tearing, compared to that of a sheet containing only alpha-spherulites.

4. Rate

The beta-nucleated sheet can also be run at higher line speeds and stretched at higher drawing rates relative to that of a non-beta-nucleated sheet. These higher drawing rates can also produce higher degrees of polymer orientation in the sheet, which can lead to improved strength and stiffness properties in the final film product.

5. Properties of Resulting Film

When a sheet containing beta-spherulites is deformed in the solid state, i.e., at a temperature below the melting point of the beta-crystals, the beta crystals can transform into alpha crystals without first melting and develop microvoids or pores. This microvoiding also can cause a non-pigmented beta nucleated sheet to become white and opaque since the microvoids scatter light. The microvoiding also results in a final stretched sheet that has a lower density than that of a stretched sheet containing only alpha-crystals.

The degree of microvoiding depends on the concentration of beta-crystals, as measured by the K-value of the sheet or the size of the beta melting peak observed in a DSC scan, and the stretching temperature. Generally, the lower the stretch temperature, the higher the level of microvoiding and the lower the density of the final oriented film. However, too low a stretching temperature can be undesirable, since such a low temperature can lead to breaking or tearing of the sheet.

The beta-nucleation concentrates described can have several advantages over the prior art. Currently, there are only two or three commercially available beta-nucleated polypropylenes. The ability to introduce a beta-nucleating agent using a concentrate can allow the end user to choose the polypropylene resin best suited for the desired application.

Using a beta nucleant masterbatch can allow for a more rapid transition from the production of a beta nucleated sheet to a non-nucleated sheet on the same extruder. If a fully formulated beta nucleated polypropylene resin is used, there is often a long transition period which follows the change-over to a non-nucleated polypropylene sheet, since all of the beta nucleant from the first resin generally must be flushed out of the system before a 100% non-nucleated sheet product can be produced. In situations where the non-nucleated polypropylene film needs to have a high level of see-through clarity the presence of any residual beta spherulites in the extruded sheet can lead to a decrease in film clarity after the sheet is stretched due to some microvoiding that may occur. By reducing the transition time between the production of beta nucleated and non-nucleated polypropylene sheet, the amount of off-grade product or scrap can be reduced.

III. Applications for Polypropylene Sheets

A. Different Applications

The extruded sheet can be one layer or multi-layered. A multi-layered sheet can contain two layers, three layers, or more than three layers. At least one of the layers can contain beta spherulites so that, in one aspect, either (1) the K parameter is in the range of from about 0.1 to about 0.95, for example, in the range of from about 0.2 to about 0.95, or (2) a prominent melting peak for the beta crystal phase can be shown when a sample of the sheet is placed in a DSC and heated at a rate of about 10° C. per minute, where, in one aspect, the heat of fusion of the beta crystal phase is at least about 5% of the heat of fusion of the alpha crystal phase. During the stretching process, the beta spherulites can undergo microvoiding, which can cause the final film to have a lower density than a polypropylene film without beta spherulites.

B. Properties of Oriented Polypropylene Films Made From Beta Nucleated Extruded Sheets

The beta-spherulite content of the sheet can be defined qualitatively by optical microscopy or quantitatively by x-ray diffraction or thermal analysis.

1. Optical Microscopy

In the optical microscopy method, a thin section microtomed from the sheet can be examined in a polarizing microscope by using crossed polars. The beta-spherulites can show up as much brighter than the alpha spherulites, due to the higher birefringence of the beta-spherulites. For the extruded sheets, the beta-spherulites can occupy at least about 20% of the field of view, for example, at least about 30% of the field of view.

2. X-ray Diffraction

In the x-ray diffraction method the diffraction pattern of the sheet can be measured, and the heights of the three strongest alpha phase diffraction peaks, H110, H130 and H040 can be determined and compared to the height of the strong beta phase peak, H300. An empirical parameter known as “K” (herein referred to as the “K-value”) can be defined by the equation:
K=(H300)/[(H300)+(H110)+(H040)+(H130)]

The K-value can vary from 0, for a sample with no beta-crystals, to 1.0 for a sample with all beta-crystals.

In one aspect, the beta-spherulite nucleating agent can be Q-dye, which can be present in the composition in an amount ranging from about 0.1 to about 50 ppm. The resulting sheet has a K-value in the range of from about 0.2 to about 0.95, for example, in the range of from about 0.3 to about 0.85. This is also a suitable range of K-values when other beta nucleants are used.

3. Thermal Analysis

Thermal analysis of the extruded sheet can be characterized by Differential Scanning Calorimetry (DSC) to determine the beta-spherulite nucleation effects. Parameters which can be measured during the first and second heat scans of the DSC can include the crystallization temperature, T_{c}; the melting temperature, Tₘ; of the alpha (α) and beta (β) crystal forms; and the heat of fusion, ΔH_{f}, including both the total heat of fusion, ΔH_{f-tot}, and the beta melting peak heat of fusion, ΔH_{f-beta}. The melting point of the beta-crystals can generally be from about 10 to about 15° C. lower than that of the alpha crystals. The magnitude of the ΔH_{f-beta}. parameter can provide a measure of how much beta crystallinity is present in the sample at the start of the heat scan. Generally, the second heat of fusion values are reported, and these values represent the properties of the material after having been melted and recrystallized in the DSC at a cool-down rate of 10° C./minute. The first heat thermal scans can provide information about the state of the material before the heat history of the processing step used to make the samples had been wiped out. The first heat thermal scan can show a distinct melting peak for the beta crystal phase, and the heat of fusion of the beta crystal phase can be at least about 5% of the heat of fusion of the alpha crystal phase.

### EXAMPLES

The following examples are put forth so as to provide those of ordinary skill in the art with a complete disclosure and description of how the compounds, compositions, articles, devices, and/or methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

The examples relate to the production of a beta nucleated concentrate and the use of this concentrate to produce an extruded sheet from which oriented film products are made. The following nonlimiting examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The beta nucleant was a red quinacridone dye, known as Hostaperm Red E3B, herein referred to as “Q-dye” (CAS No. 1047-16-1). This dye was incorporated into a polypropylene homopolymer resin (PRO-FAX 6523, produced by Basell Polyolefins) using extrusion compounding. The polypropylene resin had a melt flow rate of 4.0 g/10 min. The concentration of the Q-dye was 0.0075% (75 ppm). The final pellets of this polypropylene Q-dye concentrate had a red color. A second beta nucleant concentrate was prepared that contained a Q-dye concentration of 0.045% (450 ppm), and these pellets were also red in color. Neutral color versions of these two concentrates were also prepared by incorporating an additional amount of a non-nucleating green dye into the concentrate in sufficient quantity to neutralize the red color. The non-nucleating green dye that was used was in the form of a pellet concentrate produced by the Milliken Chemical Company, with the tradename of Cleartint Green 9807. The ratio of the Cleartint Green 9807 to that of the of the Q-dye in the neutral color beta nucleant concentrate was 100 parts of the Cleartint Green 9807 to 1 part of the Q-dye. The neutral color 75 ppm Q-dye concentrate pellets were gray in color, while the neutral color 450 ppm Q-dye concentrate pellets were almost black in color.

### Example 1

An ethylene-propylene impact copolymer identified as Dow 7C06, having a melt flow rate of 1.5 and an ethylene content of approximately 9% was used as the base resin. A pellet blend consisting of 2.5% of the 75 ppm Q-dye concentrate and 97.5% of the Dow 7C06 was extruded into sheet having a thickness of 0.59 mm using a single screw extruder operating at an output rate of about 200 kg/hour. The sheet was extruded onto a heated cast roll that was set at a temperature of 90° C. The sheet then wrapped around a second metal roll set at 25° C., and following this the sheet passed over a series of heated rolls set to a maximum temperature of 135° C. The last roll in this series was moving at a faster speed (approximately six times as fast) than that of the previous roll, and the sheet was stretched as it passed between the slow and fast rolls. This monoaxial oriented film, which was identified as film #1, had a final of 0.124 mm. This oriented final film had a white/opaque appearance due to the presence of microvoids that were generated during the stretching process, and this microvoiding resulted from the presence of beta crystals in the extruded sheet. A portion of the extruded sheet that was trimmed from the edge of the sheet before it passed through the orientation section was characterized using wide angle x-ray diffraction (WAXD), and a “K” value of 0.87 was measured.

A second film sample was made which contained 95.5% of the Dow 7C06 resin, 2.5% of the 75 ppm Q-dye concentrate, and 2% of a yellow pigment masterbatch. This film, identified as film #2, was processed using the same conditions as that of film #1. An edge trim sample of the extruded sheet from this resin blend had a “K” value of only 0.05. The low K value observed here was believed to be the result of the fact that the yellow pigment was a nucleating agent for the alpha crystalline form of polypropylene, and therefore suppressed the formation of beta crystals in the extruded sheet.

A third film sample was made which contained 95.5% of the Dow 7C06 resin, 2.5% of the 450 ppm Q-dye concentrate, and 2% of the yellow pigment masterbatch. This film, identified as film #3, was processed using the same conditions as that of film #1. An edge trim sample of the extruded sheet from this resin blend had a “K” value of 0.34.

A fourth film sample was made which contained 97.5% of the Dow 7C06 resin and 2.5% of the 450 ppm Q-dye concentrate. This sheet was extruded under the same conditions as that used for the previous sheet samples, but the maximum stretching temperature of the sheet was 125° C. This film was identified as film #6. An edge trim sample of the extruded sheet from this resin blend had a “K” value of 0.88.

### RESULTS

Various properties of the final oriented film samples were measured, and these properties are given in Table 1.

TABLE 1
Data on Monoaxially Oriented Polypropylene Films

| | | Yellow | | | | | | | Tensile | |
|---|---|---|---|---|---|---|---|---|---|---|
| | Q-dye | Master | | Stretch | | | Basis | Load @ 5% | Load @ | Break |
| Film | conc. | batch | “K” | Temp. | Thickness | Density | Weight | Elongation | Break | Elongation |
| ID | (ppm) | (%) | Value | (° C.) | (mm) | (g/cm³) | (g/m²) | (N/cm) | (N/cm) | (%) |
| 1 | 1.9 | 0 | 0.87 | 135 | 0.129 | 0.832 | 108.1 | 134 | 423 | 29.7 |
| 2 | 1.9 | 2 | 0.05 | 135 | 0.124 | 0.874 | 108.7 | 105 | 352 | 35.7 |
| 3 | 11.3 | 2 | 0.34 | 135 | 0.125 | 0.850 | 106.5 | 107 | 353 | 33.0 |
| 6 | 11.3 | 0 | 0.88 | 125 | 0.134 | 0.814 | 109.6 | 145 | 422 | 24.7 |

### DISCUSSION

The film samples made from sheets having the highest beta crystal content, namely films 1 & 6, had the lowest film densities, which indicates that that they underwent the highest degree of microvoiding. Film #6, which was stretched at a lower temperature, had the lowest density and the highest tensile load values. The breaking elongation of the films is also observed to decrease with decreasing film density.

### Example 2

In this example two different polypropylene resins were extruded into sheet with and without the addition of a beta nucleant masterbatch, and the solid sheet was stretched in the machine direction (MD) to produce monoaxially oriented polypropylene (MOPP) film. The homopolymer polypropylene (HPP) had a melt flow rate of 3.5. The impact copolymer polypropylene (ICP) had a melt flow rate of 7.5 and an ethylene content of about 8%. The extruded sheets were produced on a 2.5″ single screw extruder, and had a width of about 74 cm and a thickness of about 0.5 mm. After exiting the extrusion die the sheet was cooled by contacting it with a heated metal roll that was set at a temperature of about 88° C. The sheet was then stretched by passing it over a series of heated rolls set at a maximum temperature of 107° C. The sheet was drawn between the slow roll and the fast roll, and the final film thickness was about 75 microns. The beta nucleated versions of these sheets were produced by blending pellets of the neutral color 75 ppm Q-dye masterbatch with the each of the base polypropylene resins. Sheet and film were also produced under the same processing conditions using 100% of the base polypropylene resin. An edge trim portion of the extruded sheet of each beta nucleated resin was characterized using wide angle x-ray diffraction, in order to measure the “K” value. Various physical property tests were also performed on the film samples made from each resin.

### RESULTS

The properties of the final oriented film samples are given in Table 2.

TABLE 2
Data on MOPP Films from Example 2

| | | | | | | | MD | MD 2% | MD |
|---|---|---|---|---|---|---|---|---|---|
| | | MB | Q-dye | | | | Tensile | Secant | Break |
| Film | PP | Level | Conc. | “K” | | Density | Strength | Modulus | Elong. |
| ID | Type | (%) | (ppm) | Value | Opacity | (g/cm3) | (MPa) | (MPa) | (%) |
| 1 | ICP | 0 | 0 | — | 29.4 | 0.9041 | 270 | 2325 | 28.3 |
| 2 | ICP | 2.5 | 1.9 | 0.86 | 84.8 | 0.7921 | 272 | 2504 | 21.7 |
| 3 | HPP | 0 | 0 | — | 7.8 | 0.9095 | 350 | 3264 | 28.9 |
| 4 | HPP | 2.5 | 1.9 | 0.82 | 28.6 | 0.8890 | 363 | 3322 | 27.4 |
| 5 | HPP | 15 | 11.3 | 0.91 | 40.8 | 0.8755 | 361 | 3472 | 26.5 |

Sample #2, which is the beta nucleated version of the impact copolymer, has a much lower density and a much higher opacity than that of sample #1, which is the non-nucleated impact copolymer. A similar trend is seen when comparing the non-nucleated homopolymer, sample #3 with the two beta nucleated versions of the homopolymer, samples #4 and #5. Sample #5, which contained a higher concentration of the beta nucleant and had a higher K value, exhibited a lower density and higher opacity than that of the lower K value homopolymer, sample #4. The beta nucleated impact copolymer film had a very uniform opaque/white appearance, without the need to incorporate fillers and pigments.

Both the homopolymer and impact copolymer series of samples showed a reduction in break elongation with increasing K value, an increase in the 2% secant modulus with increasing K value, and almost no change in tensile strength with a change in K value.

This data demonstrates that beta nucleation can reduce the weight of the film by lowering its density, without sacrificing the stiffness or strength of the film, and can also produce a film having high opacity and whiteness without the use of mineral fillers or pigments. This weight reduction can significantly lower the cost of producing opaque film.

The data also shows the unexpected and superior result that beta nucleation has a much stronger influence on density reduction and opacity when it is used with impact copolymer polypropylene resins as compared to its use in homopolymer polypropylene resins. By the use of a masterbatch to incorporate the beta nucleant into the resin, the end-user has the freedom to choose the most appropriate polypropylene resin to use for a given application in terms of melt flow rate and copolymer content.

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

It is to be understood that the disclosed invention is not limited to the particular methodology, protocols, and reagents described as these may vary. It is also to be understood that the terminology used herein is for the purpose of describing particular embodiments only, and is not intended to limit the scope of the present invention which will be limited only by the appended claims.

What is claimed is:

1. A concentrate comprising a polypropylene resin and a beta-nucleating agent, wherein the nucleating agent is present in a concentration in the concentrate in a range of from about 0.005% to about 2.0%.

2. The concentrate of claim 1, wherein the nucleating agent is present in a concentration in the concentrate in a range of from about 0.0075% to about 1%.

3. The concentrate of claim 1, wherein the nucleating agent is present in a concentration in the concentrate in a range of from 0.0075% to about 0.0500%.

4. The concentrate of claim 1, wherein the polypropylene is selected from the group consisting of polypropylene homopolymer and copolymers of polypropylene containing other alpha-olefin monomers.

5. The concentrate of claim 1, wherein the polypropylene is in powder or pellet form encapsulating the nucleating agent.

6. The concentrate of claim 1, wherein the concentration is from about 50 to about 5000 ppm and wherein the beta-nucleating agent has the structural formula:

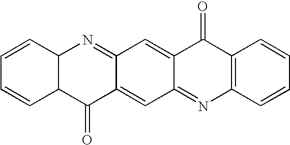

7. The concentrate of claim 6, further comprising a non-nucleating green pigment in a sufficient quantity to provide the concentrate a neutral or gray color, and did not impart any pink or red color to the final film product.

8. The concentrate of claim 1, further comprising at least one additive selected from the group consisting of stabilizers, pigments, and processing agents, wherein the additive does not nucleate the alpha crystal form of polypropylene.

9. An extruded polypropylene sheet comprising a beta-nucleating agent concentrate in a concentration of between about 0.5% to about 50% by weight of the total polypropylene content.

10. The sheet of claim 9, wherein the concentration is from about 1% to about 10% by weight of the total polypropylene content.

11. The sheet of claim 9, further comprising at least one additive selected from the group consisting of stabilizers, pigments, and processing agents, wherein the additive does not nucleate the alpha crystal form of polypropylene.

12. A method of manufacture of a beta-nucleating agent/polypropylene concentrate comprising the step of blending a substantially pure beta-nucleating agent with a substantially non-nucleated polypropylene resin to provide a concentration in the concentrate of from about 0.005% to about 2.0%.

13. The method of claim 12, wherein the blending step is conducted with a device selected from the group consisting of a twin-screw extruder and a Banbury mixer.

14. The method of claim 12, further comprising the steps of:
(a) blending a powdered polypropylene resin and a powdered beta-nucleating agent in a high intensity mixer;
(b) blending the product of step (a) with additional non-nucleated polyolefin powder in a mixer; and
(c) extruding the concentrate.

15. The method of claim 12, wherein the polypropylene is a polypropylene homopolymer or copolymer blend thereof.

16. The method of claim 12, wherein the polypropylene is a random or block copolymer selected from the group consisting of copolymers of propylene and ethylene; copolymers of propylene an α-olefin with 4 to 12 carbon atoms; copolymers of polypropylene and a mixture of α-olefins with 4 to 12 carbon atoms; and copolymers of propylene and ethylene and one or more α-olefins with 4 to 12 carbon atoms.

17. The method of claim 14, further comprising the step of adding the concentrate to polypropylene not containing nucleating agent to a final concentration of nucleating agent of from about 0.00005% to about 0.2%

18. The method of claim 17, further comprising extruding the polypropylene containing the beta-nucleating agent to form a sheet.

19. The method of claim 17, further comprising uniaxially orienting the polypropylene sheet to form a monoaxially oriented film.

20. The method of claim 17, wherein the sheet is biaxially oriented to form a biaxially oriented film.

21. A film produced by stretching the sheet of claim 9.

22. The film of claim 21, wherein the film has a density less than the density of the sheet from which it is stretched.
